(19) United States
(12) Patent Application Publication
(10) Pub. No.: US 2009/0087345 A1
(43) Pub. Date: Apr. 2, 2009

(54) DISK FOR LIQUID SAMPLE ANALYSIS

(75) Inventor: Tomohiro Yamamoto, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/282,983

(22) PCT Filed: Mar. 14, 2007
(86) PCT No.: PCT/JP2007/055118

§ 371 Date: Sep. 15, 2008

(30) Foreign Application Priority Data
Mar. 16, 2006 (JP) 2006-072224

(51) Int. Cl. B01J 19/00

(52) U.S. Cl. 422/68.1

(57) ABSTRACT

A disk for liquid sample analysis that has means for detecting any chemical reaction between liquid sample and reagent, and that among others, enhances the accuracy of detecting of components of the liquid sample through “rapidly and homogeneously” dissolving of a solid reagent in the liquid sample. In particular, there is provided a disk for liquid sample analysis comprising one or two or more chambers created in a disk-shaped member and a flow channel for inter-chamber connection, wherein a porous body is disposed in at least one of the chambers, and wherein the porous body bears a reagent capable of reacting with a specified component of the liquid sample. On this disk for liquid sample analysis, the liquid sample can be moved by centrifugal force by rotation and capillary force occurring in the chambers and flow channel.

### TECHNICAL FIELD

The present invention relates to a sample solution analyzing disk. More particularly, the present invention relates to a sample solution analyzing disk for analyzing a sample solution by reacting the sample solution such as blood supplied inside the disk with a reagent placed inside the disk and detecting the degree of chemical reaction.

### BACKGROUND ART

In recent years, advancement in analysis and testing technologies has made it possible to measure the quantity of various matter. Particularly, in the field of clinical testing, measurement systems based on specific reactions such as biochemical reaction, enzyme reaction and immune reaction are developed, which makes it possible to measure the quantity of matter in body fluids, which reflects clinical condition.

Attention is particularly focused on measurement of the quantity of matter in body fluids, which reflects clinical condition, in the field of clinical laboratory called “point of care testing (POCT).” POCT requires a simple and quick measurement method, that is, a measurement method that shortens the time from when a sample is collected until when a measurement result is obtained. Therefore, POCT requires a small and portable measuring apparatus that employs a simple measurement system and that is easy to operate.

Presently, measuring devices of practical use supporting POCT have started being provided as a result of establishment of a simple measurement system, and progress in an immobilizing technique for biogenic matter, sensor device technique, sensor system technique and micro fluid control technique. As a measuring device supporting POCT, an apparatus for qualitative analysis and quantitative analysis of a sample supplied on a disk, is proposed (for example, see Patent Document 1).

A measuring device using the technique disclosed in Patent Document 1 can be used to analyze samples such as blood and diagnose diseases. FIG. 1 is a configuration diagram showing analyzing apparatus 100 disclosed in Patent Document 1. The configuration of analyzing apparatus 100 is similar to that of what is called an “optical disk apparatus.” Analyzing apparatus 100 has: analyzing disk 101; spindle motor 201 that rotates analyzing disk 101; optical pickup 212 that irradiates sample 900 with a light beam (see FIG. 2) supplied to inside analyzing disk 101 or reagent 106 (see FIG. 2) that reacts with sample 900; and feed motor 213 for moving optical pickup 212 in the radial direction of disk 101.

FIG. 2 is a configuration diagram showing analyzing disk 101. Sample injecting hole 104 and flow path 105 are provided in analyzing disk 101, and reagent 106 whose optical characteristics (such as transmittance and color) change by reacting with the sample, is applied in flow path 105. Analyzing disk 101 in which sample 900 is injected from sample injecting hole 104, is mounted on analyzing apparatus 100.

Analyzing disk 101 mounted on analyzing apparatus 100 is rotated by spindle motor 201. Supplied sample 900 is introduced inside flow path 105 of analyzing disk 101 by centrifugal force of the rotation and reacts with reagent 106 applied inside flow path 105. After the reaction, a light beam is irradiated on sample 900 or reagent 106 inside flow path 105 using optical pickup 212 while analyzing disk 101 is rotated. By detecting a reflected light or transmitted light of the irradiated light beam, the reaction state of sample 900 or reagent 106 is detected and the sample is thereby analyzed.

An analyzing disk is proposed that has the functions of analyzing disk 101 disclosed in Patent Document 1 and an added function of freely moving and holding a sample solution so as to dissolve or react a plurality of reagents sequentially (for example, see Patent Document 2). For example, providing a plurality of chambers to which different reagents are applied and flow paths which connect the chambers, is proposed. By this means, for example, it is possible to remove the blood cells in blood by centrifugal separation and then react only the plasma components with the reagents.

A mechanism for freely moving and holding a sample solution supplied in the sample solution analyzing disk, proposed in Patent Document 2, will be described using FIG. 3. FIG. 3 shows part of the sample solution analyzing disk, from rotation center 300 to the outer circumference. Flow path 302 connects upstream chamber 301 and downstream chamber 303 in the flow of the sample solution. Connection part 301a that connects flow path 302 and upstream chamber 301 is located in a part farther from rotation center 300 in upstream chamber 301. On the other hand, connection part 303a that connects flow path 302 and downstream chamber 303 is located in a part closer to rotation center 300 in downstream chamber 303. Arrow 310 in FIG. 3 is the direction centrifugal force works.

Flow path 302 extends from connection part 301a in the direction away from rotation center 300, moves in a direction towards rotation center 300 and extends up to part 302a which is closer to rotation center 300 than the wall surface on the upstream side in upstream chamber 301, and moves in a direction away from rotation center 300 again and connects to connection part 303a.

The depth of chamber 303 is deeper than the depth of flow path 302, and so the sample solution which moves in flow path 302 by capillary action, is prevented from moving by capillary action in connection part 303a. Therefore, the sample solution stops moving in connection part 303a and does not flow into chamber 303. If centrifugal force is applied by the rotation of the disk in a state where the sample solution stays, the sample solution which stays, flows into downstream chamber 303.

Flow path 304 communicates with downstream chamber 303 and transmitted light measuring chamber 305 in the same way as flow path 302.

As described above, flow path 302 extends up to part 302a which is closer to rotation center 300 than the wall surface on the rotation center 300 side in upstream chamber 301, and then extends in a direction away from rotation center 300. Flow path 302 has such a structure, and so, by applying centrifugal force, almost all of the sample solution accumulated in upstream chamber 301 can flow into downstream chamber 303 through flow path 302 by a siphon effect.

Although the sample solution flowing into downstream chamber 303 by centrifugal force intrudes into flow path 304 by capillary action, as long as centrifugal force is at work, the sample solution cannot intrude into a part closer to rotation center 300 than the solution level of the sample solution in downstream chamber 303. Therefore, if a structure is adopted where flow path 304 extends up to part 304a closer to rotation center 300 than the wall surface on the rotation center 300 side in downstream chamber 303 in the same way as above-described flow path 302, the sample solution stops moving near part 304a while centrifugal force is at work. Accordingly, the sample solution does not flow in transmitted light measuring chamber 305.

When the sample solution analyzing disk stops rotating and centrifugal force is no longer at work, the sample solution moves in flow path 304 by capillary action, reaches connection part 305a of transmitted light measuring chamber 305, which is the next chamber, and stays.

If centrifugal force is applied again in a state where the sample solution stays in connection part 305a, the sample solution flows in transmitted light measuring chamber 305. By measuring the transmitted light of the sample solution flowing in transmitted light measuring chamber 305, a specific component in the sample solution can be detected. If centrifugal force stops working in this state, cases may occur where the sample solution that has flown into transmitted light measuring chamber 305, flows back to flow path 304, and the sample solution in transmitted light measuring chamber 305 runs short. Therefore, centrifugal force is preferably at work during measurement of transmitted light.

Further, by providing air holes 306, 307 and 308 in parts of the upper parts of the chambers, where the sample solution does not reach, the sample solution can flow into the chambers more smoothly, so that it is possible to dissolve the reagent in the sample solution well and react the reagent with the sample solution.

By drying the reaction reagent required for measuring a specific component in the sample solution and making downstream chamber 303 of the sample solution analyzing disk shown in FIG. 3 support the reaction reagent, a layer of the reaction reagent can be placed in downstream chamber 303. For example, the layer of the reaction reagent can be placed by dropping in downstream chamber 303 an aqueous solution with the reagent concentration higher than the concentration required for reaction and drying it, or by dropping and drying a reagent solution, for which the concentration and drop amount are set so that downstream chamber 303 can support the amount of the reagent required for reaction with the reagent solution of the capacity of downstream chamber 303.

### Patent Document 1: International Publication No. 0026677 Pamphlet

### Patent Document 2: Japanese Patent Application Publication No. 2002-534096

### DISCLOSURE OF INVENTION

### Problems to be Solved by the Invention

By using the conventional sample solution analyzing disk shown in FIG. 3, a device for measuring components of various sample solutions can be built. For example, by placing the reaction reagent relating to the reaction mechanism shown below, in the chamber of the sample solution analyzing disk, the concentration of TG (triglyceride) in plasma, that is, neutral fat can be measured.

TG→glycerol(enzyme:lipoprotein lipase) (A)

glycerol+NAD→dihydroxyacetone+NADH(enzyme:glycerol dehydrogenase) (B)

NADH+WST-9→NAD+formazan(enzyme:diaphorase)WST-9:2-(4-nitrophenyl)-5-phenyl-3-[4-(4-sulfophenyl azo)-2-sulophenyl]-2H-tetrazolium) (C)

Further, by placing the reaction reagent relating to the reaction mechanism shown below, in the chamber of the sample solution analyzing disk, the concentration of total cholesterol in plasma can be measured (in the following equation Y, NADH is a reductant of NAD).

EC(cholesterol ester)→Chol(cholesterol)(enzyme:cholesterol esterase(ChE)) (X)

Chol+NAD(nicotine adenine dinucleotide)→cholestenon+NADH(enzyme:cholesterol dehydrogenase(ChDH)) (Y)

NADH+WST-9→NAD+formazan(enzyme:diaphorase) (Z)

Further, plasma dissolved with a polycation compound and divalent cation of adequate concentration is placed for several minutes, to aggregate lipoproteins other than high density lipoprotein (HDL) among the lipoproteins in plasma. By removing the aggregate through centrifugal separation, etc. and causing the reactions of the above-described reaction equation (X) to (Z) sequentially, the concentration of “HDL cholesterol (good cholesterol)” can be measured.

The method of removing lipoproteins other than HDL by aggregating and precipitating the lipoproteins other than HDL, is known as the “precipitation method.” To aggregate and precipitate the lipoproteins other than HDL, it is important to dissolve reagents (a polycation compound and divalent cation) uniformly in a sample solution.

Even if a layer of reaction reagents (a polycation compound and divalent cation) is formed in chamber 303 of the sample solution analyzing disk shown in FIG. 3 by drying a reagent solution, and plasma is made to flow into chamber 303 where a layer of the reaction reagents is formed, it is difficult to aggregate the lipoproteins other than HDL selectively among lipoproteins, because when the sample solution (plasma) flows into chamber 303 first, a large amount of reaction reagent dissolves in the sample solution, not only the lipoproteins other than HDL, but also HDL are aggregated, and consequently the cholesterol contained in HDL are also precipitated and removed. Therefore, HDL cholesterol is difficult to be measured correctly using the conventional sample solution analyzing disk.

It is therefore an object of the present invention to provide a disk for analyzing a sample solution with a means for detecting chemical reaction of a sample solution and a reagent, and, particularly, a disk for analyzing a sample solution with improved accuracy of detecting components in a sample solution by dissolving a solid reagent in a sample solution quickly and homogeneously.

### Means for Solving the Problem

A first aspect of the present invention relates to the following disk for analyzing a sample solution. [1] A disk for analyzing a sample solution including: one or more chambers with one or more opening parts which are provided in a disk member and which are formed with space; a flow path which connects with the opening part; a porous body which is placed in at least one of the chambers; and a reagent which impregnates the porous body and which includes a chemical substance that reacts with a specific component in the sample solution and that is soluble in the sample solution, and in the sample solution analyzing disk, as a means for delivering the sample solution to the flow path and the chambers, a centrifugal force caused by rotation of the disk and a capillary force produced in the chambers and the flow path can be used; the sample solution flows into the chamber in which the porous body is placed in, through one of the opening parts by the centrifugal force caused by the rotation of the disk; and the disk adopts a structure so that the centrifugal force can be set in a range such that the sample solution is stored in the porous body from making the porous body soak in the sample solution until dissolving of the chemical substance that impregnates the porous body in the sample solution, and the sample solution in which the porous body is soaked can be squeezed from the porous body when the centrifugal force is increased by an increase of the number of the rotations of the disk.

[2] The disk according to [1], the number of the chambers provided in the disk member is two or more, and the chambers communicate with each other through the flow path.

A second aspect of the present invention relates to the following disk for analyzing a sample solution. [3] A disk for analyzing a sample solution including: one or more chambers with one or more opening parts which are provided in a disk member and which are formed with space; a flow path which connects with the opening part; a porous body which is placed in at least one of the chambers; and a reagent which impregnates the porous body and which includes a chemical substance that reacts with a specific component in the sample solution and which is soluble in the sample solution, and in the sample solution analyzing disk, as a means for delivering the sample solution to the flow path and the chambers, a centrifugal force caused by rotation of the disk and a capillary force produced in the chambers and the flow path can be used; the porous body is placed so as to be exposed from the chamber, which is allowed to be impregnated with the sample solution from outside the disk member, and placed closer to a center of rotation of the disk member than the chamber; and the disk adopts a structure so that the sample solution which impregnates the porous body can be stored in the porous body until a reagent supported in the porous body dissolves in the sample solution, and the sample solution in which the porous body is soaked can be squeezed from the porous body by the centrifugal force caused by the rotation of the disk.

[4] The disk according to [1], the number of the chambers provided in the disk member is two or more, and the chambers communicate with each other through the flow path.

### ADVANTAGEOUS EFFECT OF THE INVENTION

According to the disk for analyzing a sample solution of the present invention, it is possible to analyze the sample solution by detecting chemical reactions between a sample solution to be supplied and a solid reagent placed in a disk (for example, a chamber in the disk), and to dissolve the solid reagent in the sample solution quickly and uniformly (that is, dissolve the solid reagent in a uniform concentration distribution). Therefore, even if reactions vary depending on the concentration of the reagent, variation in reactions can be controlled, so that it is possible to improve the accuracy of analysis of the disk.

Further, according to the disk for analyzing a sample solution of the present invention, the sample solution in which a reagent dissolves can be easily collected, so that the collected sample solution can be provided for the next reaction and measurement in a simple manner. Further, if the reaction between the sample solution and the reagent produces an aggregate, or if the sample solution before the reaction contains solid matter, an aggregate or solid matter can be removed in a simple manner when the sample solution after the reaction is collected.

By detecting specific components in a sample solution through chemical reaction detection using the disk for analyzing a sample solution of the present invention, it is possible to improve the accuracy and promptness of detection.

### BRIEF DESCRIPTION OF DRAWINGS

FIG. 1 is a configuration diagram showing a conventional sample solution analyzing apparatus;

FIG. 2 is a cross-sectional view showing an example of a sample solution analyzing disk used in the conventional sample solution analyzing apparatus;

FIG. 3 is a schematic diagram illustrating the mechanism of moving a sample solution in the conventional sample solution analyzing disk;

FIG. 4 shows an example of arrangement of a porous body provided in a disk member of a sample solution analyzing disk;

FIG. 5 shows another example of arrangement of the porous body provided in the disk member of the sample solution analyzing disk;

FIG. 6 is a plan view showing the configuration of a chamber and a flow path part of the first example of the sample solution analyzing disk;

FIG. 7 is a plan view showing the configuration of a chamber and a flow path part of the second example of the sample solution analyzing disk;

FIG. 8 is a plan view showing the configuration of a chamber and a flow path part of the third example of the sample solution analyzing disk;

FIG. 9 is a plan view showing the configuration of a chamber and a flow path part of the fourth example of the sample solution analyzing disk;

FIG. 10 is a plan view showing the configuration of a chamber and a flow path part of the fifth example of the sample solution analyzing disk;

FIG. 11 is a configuration diagram showing an analyzing apparatus including a rotating structure and a sample solution analyzing disk held by the rotating structure; and

FIG. 12 is a graph showing a result of measuring the concentration of HDL cholesterol in plasma using the sample solution analyzing disk of the present invention.

### BEST MODE FOR CARRYING OUT THE INVENTION

The sample solution analyzing disk of the present invention has a disk member. The shape of the disk member may be round but is not particularly limited, and the disk member only has to have the center of rotation of the sample solution analyzing disk. A sample solution can be delivered to the chamber or the flow path (described later) provided in the disk member using centrifugal force caused by the rotation of the sample solution analyzing disk as a delivering means. Further, a sample solution can be delivered to the chamber or the flow path (described later) using capillary force produced in the chamber or the flow path as a delivering means.

One or more chambers, generally two or more chambers, are provided in the disk member of the sample solution analyzing disk. Examples of chambers include: a storage chamber which stores a sample solution supplied from outside; a reagent chamber in which a reagent to react with the sample solution is placed; and a measuring chamber into which the sample solution after reaction with the reagent flows, and which serves as the part for measuring properties (such as absorbance and electrical characteristics).

Each chamber has one or more opening parts. The opening part may be connected to a flow path or used as an air vent. A chamber usually has an opening part for making a sample solution flow into the chamber and an opening part for draining the sample solution. However, for example, the measuring chamber does not necessarily require an opening part for draining the sample solution and may have only one opening part.

Preferably, a chamber provided in the disk member is usually a sealed space except that the chamber has one or more opening parts. The depth of the chamber is usually deeper than the depth of the flow path. Therefore, Preferably, the depth of the chamber is approximately 0.2 mm or more with respect to the disk plane. On the other hand, the depth of the chamber is approximately 1 mm or less in view of ease of processing. Further, when the depth of the chamber is too deep, the sample solution flows more actively in the chamber, and so cases may occur where it is not possible to take advantage of a capillary valve when the rotating disk is placed still. The area of the chamber is adjusted as appropriate according to the volume of the sample solution introduced. The volume of the sample solution introduced is usually 100 μl or less, and so the area of the chamber may be approximately 2 to 100 mm². Further, although the area of the chamber is set according to the projected area of the disk, the projected area of the disk cannot be made very large, and so the area of the chamber is preferably set in the above range.

Two or more chambers communicate with each other through the flow path, so that the sample solution can move between the chambers. Two or more chambers are preferably placed to move away from the center of rotation of the sample solution analyzing disk in the order of connections to move the sample solution in the chambers gradually using centrifugal force.

The disk member of the sample solution analyzing disk has one or more flow paths. The flow paths are connected to the opening parts of the chambers. When two or more chambers are provided in the disk member, the chambers communicate with each other through the flow paths.

The flow paths formed in the disk member preferably allows the sample solution to move by capillary action. Preferably, the depth of the flow path is approximately 50 μm to 300 μm with respect to the disk plane, and the width of the flow path is approximately 0.2 mm to 1.5 mm.

By centrifugal force caused by the rotation of the sample solution analyzing disk and capillary force produced in the chamber and the flow path, a sample solution can move inside the chamber and the flow path provided in the disk member.

The pathway of the flow path which connects a “chamber closer to the center of rotation” and a “chamber farther from the center of rotation” may be (1) a combination of a pathway moving away from the center of rotation and a pathway coming closer to the center of rotation, or (2) a pathway that moves straight away from the center of rotation.

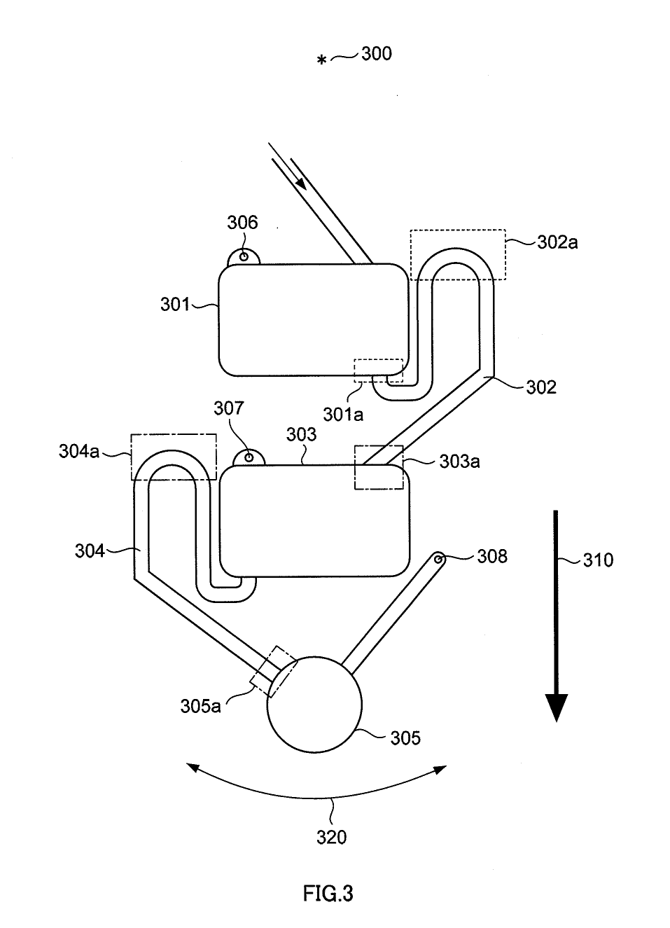

(1) Examples of a flow path with a pathway that combines a pathway moving away from the center of rotation and a pathway coming closer to the center of rotation include a flow path (302 or 304) formed in the sample solution analyzing disk shown in FIG. 3, which is illustrated as the related art. If chambers communicate with each other through the flow path with such a pathway, the sample solution can be gradually delivered into the chambers easily.

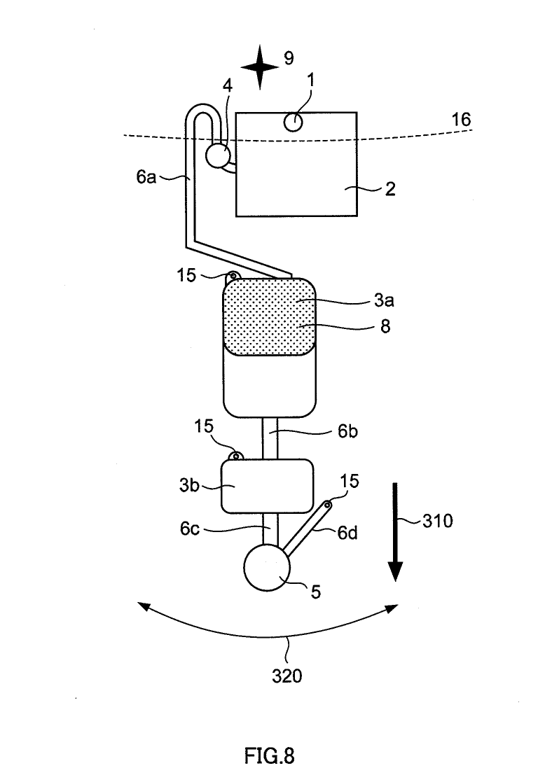

(2) Examples of a flow path with a pathway that moves straight away from the center of rotation include the flow path (6b or 6c) shown in FIG. 8. If the chambers communicate with each other through the flow path with such a pathway, by controlling the cross-sectional area of the flow path and the level of hydrophobicity of the inner wall of the flow path, the deterrent force against the intrusion of the sample solution into the flow path is adjusted. By this means, the sample solution can be moved to the chambers gradually. The adjustment of deterrent force against the intrusion of the sample solution to the flow path will be described in detail later.

Further, a porous body is placed in at least one of the chambers provided in the disk member of the sample solution analyzing disk of the present invention. The porous body placed in a chamber may be placed in the inner space of the chamber or placed so as to be exposed outside. When the chamber has the porous body placed in the inner space, the sample solution can flow in to the chamber through the flow path. On the other hand, when the chamber has the exposed porous body, the sample solution can be supplied from outside the disk.

The porous body, when placed in the inner space of the chamber, may be placed in the whole of the inner space of the chamber (that is, the porous body and the inner space are the same size), or may be placed in the part of the inner space of the chamber (that is, the inner space of the chamber has an “empty space” where the porous body is not present).

When the porous body is placed in only part of the inner space of the chamber, the porous body is preferably placed at the position near the center of rotation of the sample solution analyzing disk. That is, an empty space is formed at the position farther from the center of rotation, in the inner space of the chamber. The porous body placed in only part of the inner space of the chamber is preferably placed in the part of the inner space without space. For example, “the cross-section which is orthogonal to the centrifugal direction of the rotation of the disk, of the internal part of the chamber” and “the cross section which is orthogonal to the centrifugal direction of the rotation of the disk, of the porous body placed in the chamber” have the same shape and the same size to impregnate the porous body with all of the sample solution supplied to the chamber.

The sample solution which has reacted with a reagent in the porous body, moves to the empty space.

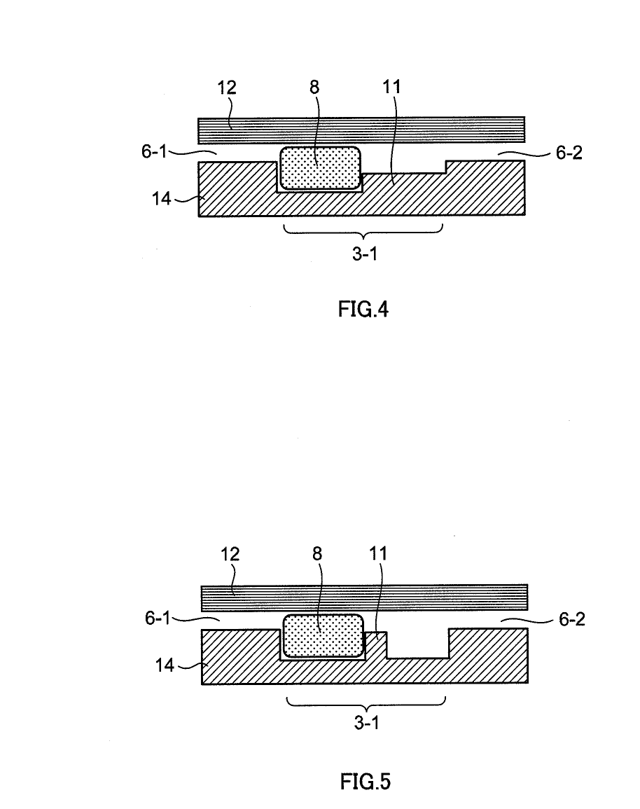

FIG. 4 and FIG. 5 show examples of placing a porous body in part of inner space of a chamber. Chamber 3-1 in FIG. 4 and FIG. 5 is connected to flow path 6-1 and flow path 6-2. Chamber 3-1, flow path 6-1 and flow path 6-2 are formed with lower substrate 14, spacer 13 (not shown) that forms the flow path, and upper substrate 12. Flow path 6-1 is placed closer to the center of rotation of the sample solution analyzing disk than flow path 6-2.

Stopper 11 may be placed in, for example, lower substrate 14 to provide steps so that chamber 3-1 can fix porous body 8 in a predetermined position even if centrifugal force works by the rotation of the disk. Stopper 11 may be partially provided as shown in FIG. 5, or the whole part farther from porous body 8 in chamber 3-1 may be made shallow by stopper 11 as shown in FIG. 4. However, if the structure shown in FIG. 4 is adopted, cases may occur where the sample solution held in the porous body is sucked out from porous body 8 by capillary action and porous body 8 cannot hold the sample solution. In this case, it is preferable to adopt the structure shown in FIG. 5.

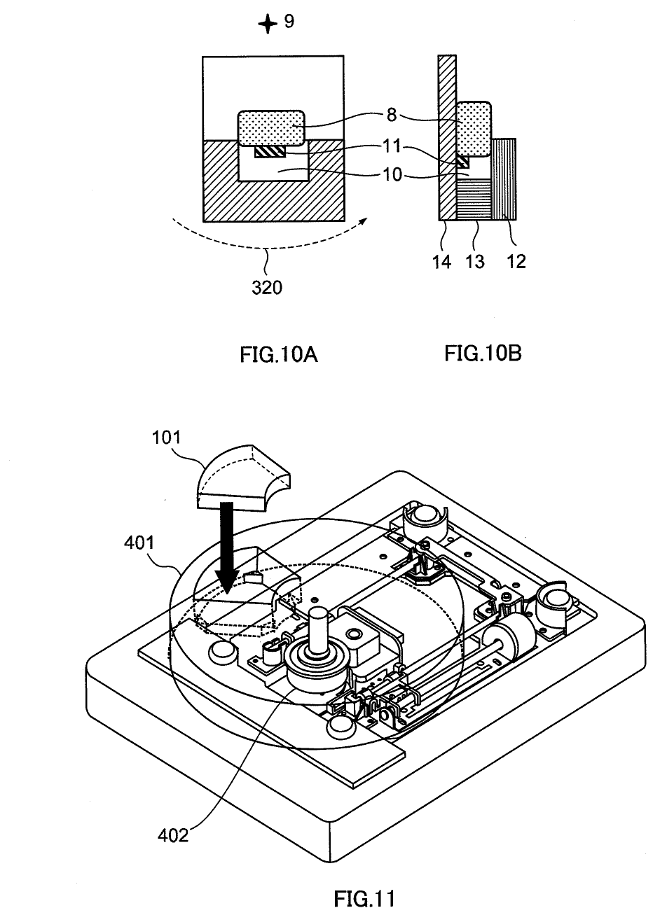

On the other hand, FIG. 10 shows an example where the exposed porous body is placed in the chamber. Drops of the sample solution can be dispensed directly in the exposed porous body 8 from outside. As shown in FIG. 10A, porous body 8 is preferably placed closer to rotation center 9 of the sample solution disk than chamber 10. The dispensed sample solution is squeezed to chamber 10 by centrifugal force caused by the rotation of the sample solution analyzing disk.

Examples of the porous body placed in the chamber include a non-woven fabric made of glass fiber or polymer fiber such as cellulose, and a spongy structure having a porous structure. Further, the material of the porous body is not particularly limited, as long as the material does not chemically react with the sample solution and the reagent. A non-woven glass fabric is particularly preferable.

The porous body can hold the sample solution supplied to the sample solution analyzing disk. “Holding” a solution means absorbing liquid inside and keeping the liquid inside.

The capacity of the porous body to hold the sample solution (holding volume) is preferably greater than the volume of the sample solution supplied to the sample solution analyzing disk to make all of the sample solution supplied for analysis be absorbed in the porous body and cause some kind of reaction in the inner space of the porous body. Although the volume of liquid the porous body can hold is specified by the material and the dimensions of the porous body, preferably, the holding volume is approximately 2.0 to 10.0 μl, to be used in the sample solution analyzing disk of the present invention. For example, a non-woven glass fabric can hold approximately 90% of the sample solution with respect to the volume of the non-woven fabric.

Further, the porous body preferably has a capacity (holding capacity) to hold some of the sample solution absorbed inside. This is because, even if centrifugal force works on the sample solution absorbed in the porous body, the sample solution is not squeezed from the porous body by the holding capacity and is held in the porous body until required reaction is finished.

Even if centrifugal force is applied through the minimum number of disk rotations the sample solution requires for moving, it is necessary to prevent the sample solution from draining from the farther side of the porous body from the center of rotation. Therefore, preferably, the location of the porous body in the disk (particularly, the distance from the center of rotation to the farther side of the porous body from the center of rotation), the minimum number of rotations to be set to the disk for liquid transfer operation, and the volume of the sample solution supplied to the porous body are set, and the dimensions and material of the porous body are experimentally determined so that the sample solution is all absorbed in the porous body and does not leak out under the set conditions.

The porous body placed in at least one chamber supports a reagent that reacts with a specific component in the sample solution supplied to the sample solution analyzing disk. The supported reagent is preferably soluble in the sample solution.

The reagent supported in the porous body is not particularly limited as long as the reagent reacts with a specific component contained in the sample. However, the reagent causing reaction that is easily influenced by the concentration distribution of the dissolved reagent, would work to improve the advantage of the present invention. For example, if the sample solution is plasma, the porous body supports a reagent containing a polyanion compound or its salt and a compound that produces a divalent positive ion in plasma. By this means, the proteins other than HDL, among lipoproteins in plasma, are aggregated. Examples of anion compounds include heparin, dextran sulfate and phosphotungstic acid. Examples of divalent positive ions include magnesium ions and calcium ions.

To make the porous body support the reagent, for example, a solution containing the reagent may be dropped in the porous body, and the solution may be dried (for example, dried in air).

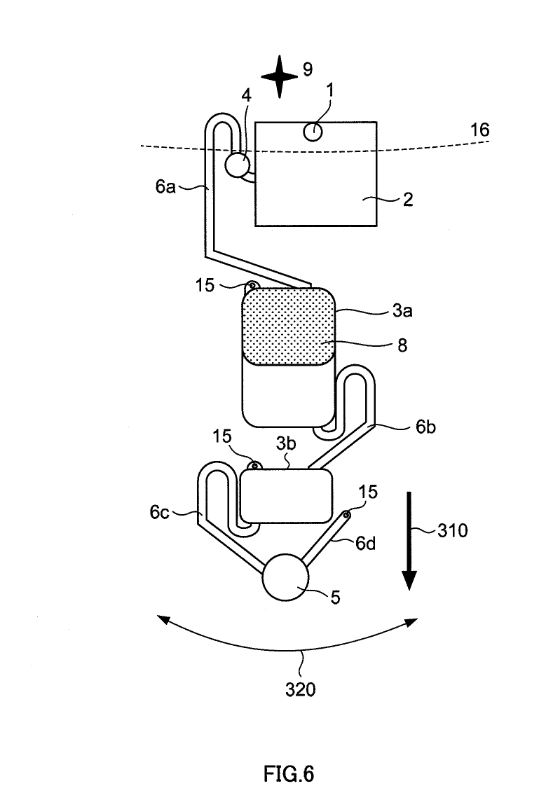

The material of the disk member is usually a resin. As shown in FIG. 4, FIG. 5 or FIG. 10B, the sample solution analyzing disk has lower substrate 14, spacer 13 and upper substrate 12. Concave parts which serve as sample solution storing chamber 2, reagent chamber 3, measuring chamber 5 and flow path valve 4 (see FIG. 6), are formed in lower substrate 14. The concave parts in lower substrate 14 can be formed by machine processing or injection molding. Spacer 13 is a plate material in which a part that matches a plane pattern of the flow path is cut out. Upper substrate 12 is a plate material that covers the whole of the flow path and chamber, and sample solution supply port 1 and air vent 15 (see FIG. 6) are formed in upper substrate 12.

The sample solution analyzing disk can be formed by placing a solid reagent and porous body 8 in the chamber part in lower substrate 14 and then pasting spacer 13 and upper substrate 12 to lower substrate 14. Spacer 13 and upper substrate 12 are pasted by, for example, applying an adhesive on both faces of spacer 13 and pasting lower substrate 14 and upper substrate 12 with the faces of spacer 13. Instead of pasting spacer 13 and upper substrate 12 using an adhesive, it is also possible to paste them using a thermosetting adhesive or by ultrasonic bonding. Further, any method can be used to perform pasting as long as the method does not alter or denaturalize the measurement reagent.

The chamber and flow path in the sample solution analyzing disk may be formed integrally or may be provided in the disk member as a replaceable member. For example, the lower substrate, spacer and upper substrate configuring the disk member may be also used as the lower substrate, spacer and upper substrate of the chamber and the flow path. Further, it is also possible to form the disk member, and the chamber and flow channel with different members and mount the chamber and flow path on the disk member.

To analyze a sample solution using the sample solution analyzing disk of the present invention, it is only necessary to (1) irradiate the sample solution with a light, that has reacted with a predetermined reagent, and measure (measure optically) the absorbance or transmittance, or (2) measure (measure electrically) the current level flowing in the sample solution that has reacted with a predetermined reagent. It is also possible to analyze the sample solution using other means.

For example, to optically measure the concentration of cholesterol (i.e., the concentration of HDL cholesterol) in the sample solution from which lipoproteins other than HDL in plasma contained in the sample solution, are removed, by causing electrontransfer of the HDL cholesterol in the sample solution between (1) an enzyme that converts cholesterol ester to cholesterol (cholesterol esterase), (2) an enzyme that oxidizes cholesterol (for example, cholesterol dehydrogenase), (3) NAD (nicotine adenine dinucleotide) which is a reagent for mediating electron transfer by the oxidization of the cholesterol, and (4) NADH, which is a reductant of NAD, and by reacting the HDL cholesterol with a pigment such as WST-9, absorbance of which changes, the change in the absorbance of the sample solution before and after the reaction may be measured.

On the other hand, to measure the concentration of HDL cholesterol electrically, in the same way as the above method of optical measurement of the concentration of HDL cholesterol, through the reaction catalyzed by cholesterol esterase and cholesterol dehydrogenase, a redox compound which can be electron-transferred to NADH, is reacted with the HDL cholesterol in the sample solution, and, when an electrode provided for measurement is set an appropriate potential after the reaction, the current flowing in the sample solution may be measured. Examples of the redox compound include potassium ferricyanide that generates ferricyanide ions in an aqueous solution, and the ferricyanide ions are reduced to be ferrocyanide ions. The current flowing in the sample solution may be measured by providing electrodes that serve as the counter electrode and the active electrode at least in the measuring chamber (see FIG. 6), applying a voltage, and measuring the oxidation current level which is produced when the reductant (such as a ferrocyanide ion) is oxidized. The analyzing apparatus preferably has terminals for contacting the electrodes from outside the disk.

Preferred embodiments of the present invention will be described below with reference to the accompanying drawings. In the following description, the same or equivalent components will be assigned the same reference numerals without further explanations.

### A First Example of the Sample Solution Analyzing Disk

FIG. 6 is a plan view showing the configuration of a first example of the sample solution analyzing disk and shows part from rotation center 9 toward outside the radial direction. The sample solution analyzing disk has: sample solution storing chamber 2 which has sample solution supply port 1; reagent chamber 3a in which a porous body is placed; reagent chamber 3b; and measuring chamber 5. Further, the sample solution analyzing disk has: flow path 6a through which sample solution storing chamber 2 and reagent chamber 3a communicate; flow path 6b through which reagent chamber 3a and reagent chamber 3b communicate; flow path 6c through which reagent chamber 3b and measuring chamber 5 communicate; and flow path 6d which is connected to measuring chamber 5 and has air vent 15 in one end. Flow path valve 4 for controlling the drain of the sample solution from sample solution storing chamber 2 is provided in flow path 6a. In FIG. 6, arrow 310 shows the direction centrifugal force works, and arrow 320 shows the direction the disk rotates.

Flow path 6a extending from sample solution storing chamber 2 extends up to the part closer to rotation center 9 than solution level 16 of the sample solution stored in sample solution storing chamber 2, and extends up to a part connecting with reagent chamber 3a. Flow path 6b extends from the part near the end part farther from rotation center 9, in reagent chamber 3a, extends up to the part closer to rotation center 9, and then extends up to a part connecting with reagent chamber 3b.

Porous body 8 placed in reagent chamber 3a is placed in part closer to rotation center 9, in reagent chamber 3a. Porous body 8 is shaped so that the cross section parallel to the rotation direction matches the cross section of reagent chamber 3a to allow all of the reagent flowing into reagent chamber 3a to be absorbed in porous body 8.

Porous body 8 preferably supports a solid reagent, and, more preferably, supports the solid reagent uniformly. The solid reagent supported in porous body 8 has an extremely large surface area, and therefore dissolves quickly in the sample solution absorbed in the porous body.

The solid reagent is also placed in reagent chamber 3b. For example, a solution of the solid reagent may be dropped and dried on the wall surface of reagent chamber 3b, or a reagent solidified by a freeze-drying method may be placed in reagent chamber 3b.

The sample solution to be analyzed is supplied in the sample solution analyzing disk (described later). The volume of liquid porous body 8 placed in reagent chamber 3a can hold is preferably larger than the volume of the sample solution to be introduced. That is, the total volume of void in porous body 8 is preferably larger than the volume of the sample solution to be introduced.

To analyze the sample solution using the sample solution analyzing disk shown in FIG. 6, the sample solution is supplied to sample solution supply port 1. The supplied sample solution is once stored in sample solution storing chamber 2. It is also possible to adopt a configuration where sample solution storing chamber 2 is not provided and the sample solution is directly supplied (drops of the sample solution are dispensed) to reagent chamber 3b in which the porous body is placed (see FIG. 10). In this case, the rate the sample solution flows into reagent chamber 3a may change depending on how drops of the sample solution are dispensed, and so, preferably, attention is paid to the reproducibility of a dissolved state of the solid reagent supported in the porous body, in the sample solution.

When solid matter contained in the sample solution needs to be removed, the solid matter may be removed by centrifugal separation processing in sample solution storing chamber 2. For example, if the sample solution is blood, solid matter such as blood cells may be removed in advance.

To once prevent the sample solution stored in sample solution storing chamber 2 from draining to flow path 6a, flow path valve 4 is provided. In flow path valve 4, the width and/or height of flow path 6a are increased discontinuously. Therefore, the sample solution flowing into flow path 6a by capillary action stays in flow path valve 4 (the part where the width and height are increased discontinuously) of flow path 6a. Techniques of controlling a flow by capillary action in this way are generally known.

Flow path valve 4 is preferably placed in the position farther from rotation center 9 than solution level 16 of the sample solution stored in sample solution storing chamber 2 upon the rotation of the sample solution analyzing disk. When the sample solution analyzing disk is rotated, the sample solution moves by centrifugal force and exceeds flow path valve 4. While centrifugal force is at work, the sample solution having exceeded flow path valve 4 by centrifugal force, cannot come closer to rotation center 9 than solution level 16 of the sample solution. However, when the rotation stops and centrifugal force ceases working, the sample solution proceeds in flow path 6a by capillary action and reaches the part connecting with reagent chamber 3a.

The depth of reagent chamber 3a is made equal to the thickness of porous body 8 as described later. Therefore, generally, the depth of reagent chamber 3a is greater than the height of flow path 6a. Accordingly, the sample solution moving in flow path 6a by capillary action stops in the part connecting with reagent chamber 3a. If the height of flow path 6a and the height of reagent chamber 3a are equal, a valve may be provided near the part connecting reagent chamber 3a and flow path 6a.

When the sample solution reaches the part connecting reagent chamber 3a and flow path 6a, the disk is rotated. By the centrifugal force caused by the rotation of the disk, the sample solution flows into reagent chamber 3a. As described above, porous body 8 is shaped so that the cross section parallel to the direction of rotation matches the cross section of reagent chamber 3a, and so all of the sample solution flowing into reagent chamber 3a is absorbed in porous body 8.

To make all of the sample solution flowing into reagent chamber 3a be absorbed in porous body 8, centrifugal force caused by rotating the disk does not preferably exceed the capacity porous body 8 can retain the sample solution, that is, the “holding capacity” of porous body 8.

After porous body 8 is entirely impregnated with the sample solution and the solid reagent supported in porous body 8 completely dissolves, the rotation speed of the disk is further increased to increase centrifugal force at work. If centrifugal force exceeds the capacity porous body 8 can hold the sample solution (holding capacity), the sample solution is squeezed from the farther side of porous body 8 from rotation center 9.

Porous body 8 is placed at the position closer to rotation center 9 in reagent chamber 3a, and an empty space is provided at the position farther from rotation center 9. The volume of the empty space is preferably equal to or greater than the volume of the solution squeezed from porous body 8 by the rotation of the disk, out of the sample solution held in porous body 8 to store in the empty space all of the sample solution squeezed from porous body 8 by the centrifugal force caused by the rotation of the sample solution analyzing disk. The aggregate produced by the reaction caused by the solid reagent supported in porous body 8, and the solid matter which transmits through porous body 8, may be removed by centrifugal separation processing in the empty space.

When the rotation of the sample solution analyzing disk is stopped after the sample solution is squeezed in the empty space of reagent chamber 3a, the sample solution moves inside flow path 6b by capillary action and reaches before reagent chamber 3b. Reagent chamber 3b includes a solid reagent.

Then, by guiding the sample solution to measuring chamber 5 by the operation of rotating and stopping the sample solution analyzing disk and optically measuring chemical reactions of the sample solution in measuring chamber 5 using absorbance, for example, the quantity of a desired specific component can be measured.

### A Second Example of the Sample Solution Analyzing Disk

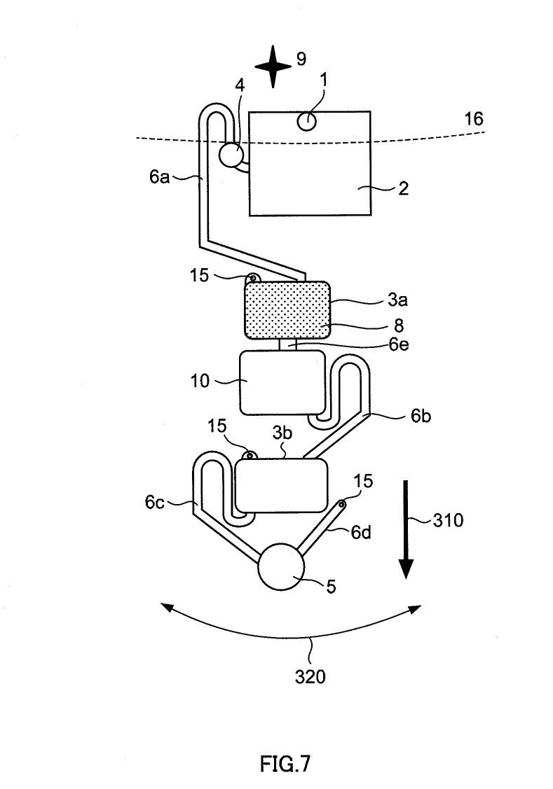

FIG. 7 is a plan view showing the configuration of a second example of the sample solution analyzing disk and shows part from rotation center 9 toward the radial direction. The sample solution analyzing disk shown in FIG. 7 has aggregate separating chamber 10 that is connected to reagent chamber 3a where a porous body is placed, via flow path 6e. Porous body 8, which has the same size and the same shape as the interior shape of reagent chamber 3a, is placed in reagent chamber 3a of the sample solution analyzing disk shown in FIG. 7. The sample solution squeezed from placed porous body 8 by centrifugal force flows into aggregate separating chamber 10 and is stored. The capacity of chamber 10 is preferably greater than the volume of liquid squeezed from porous body 8 by the rotation of the disk, out of the sample solution held in porous body 8.

Flow path 6e extends linearly from reagent chamber 3a toward aggregate separating chamber 10 in the direction away from rotation center 9. Therefore, when the rotation speed of the sample solution analyzing disk is increased, the sample solution squeezed from porous body 8 flows into aggregate separating chamber 10 quickly. In aggregate separating chamber 10, the solid matter may be removed by centrifugal separation processing as appropriate. The sample solution analyzing disk in FIG. 7 is particularly suitable when porous body 8 is not thick enough. The other members are the same as those in the sample solution analyzing disk shown in FIG. 6.

### A Third Example of the Sample Solution Analyzing Disk

FIG. 8 is a plan view showing the configuration of a third example of the sample solution analyzing disk and shows part from rotation center 9 toward the radial direction. The configuration of the chamber of the sample solution analyzing disk shown in FIG. 8 is the same as the chamber of the sample solution analyzing disk shown in FIG. 6. The sample solution analyzing disk shown in FIG. 8 is different from the sample solution analyzing disk shown in FIG. 6 in that flow path 6b and flow path 6c that connect the chambers of the sample solution analyzing disk shown in FIG. 8, extend linearly in the direction away from the center of rotation (have pathways that move straight away from the center of rotation).

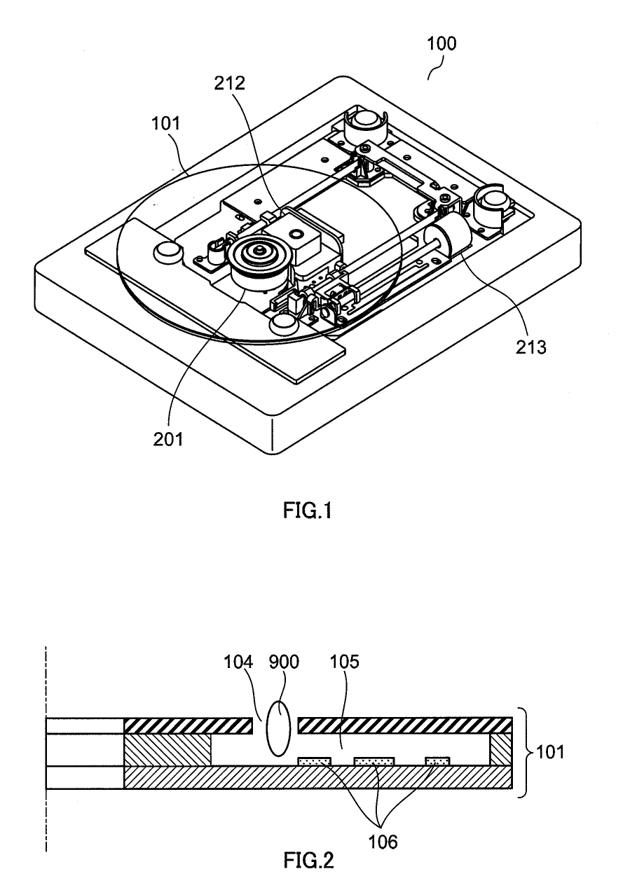

Compared to the sample solution analyzing disk shown in FIG. 1, the sample solution analyzing disk shown in FIG. 8 has an advantage of requiring a few members to configure flow paths and chambers. On the other hand, the sample solution analyzing disk shown in FIG. 8 needs to design flow path 6b or flow path 6c precisely. For example, when the disk is rotated to transfer the sample solution from reagent chamber 3a, which is closer to the center of rotation, to reagent chamber 3b, the sample solution transferred to reagent chamber 3b may not stay in reagent chamber 3b and may flow into measuring chamber 5.

By the centrifugal force caused by the rotation of the sample solution analyzing disk, the force the sample solution passes the part connecting reagent chamber 3a and flow path 6b and flows into flow path 6b, depends on (1) the distance from the solution level of the sample solution in reagent chamber 3a immediately after the rotation, to the part connecting reagent chamber 3a and flow path 6b, (2) the number of rotations, and (3) the distance from the center of rotation to the part connecting reagent chamber 3a and flow path 6b. On the other hand, there is a deterrent force against the in flow of the sample solution in reagent chamber 3a into flow path 6b. Although the deterrent force depends on the surface tension of the sample solution to the inner wall surface of flow path 6b and viscosity of the sample solution, with respect to the sample solution, generally, the deterrent force becomes greater when the cross-sectional area of flow path 6b is smaller. Further, when the inner wall surface of the flow path is made more hydrophobic, the deterrent force becomes greater.

Therefore, by setting the cross-sectional area of flow path 6b adequately, it is possible to retain in chamber 3a the sample solution squeezed from porous body 8 by the centrifugal force caused by a certain number of rotations α, without moving the sample solution to reagent chamber 3b. By increasing the number of rotations α to the number of rotations β, the sample solution retained in chamber 3a is made to flow into chamber 3b. Further, the sample solution flowing into chamber 3b by centrifugal force caused by the number of rotations β preferably stays in reagent chamber 3b without moving to measuring chamber 5. Therefore, a cross-sectional area of flow path 6c through which reagent chamber 3b and measuring chamber 5 communicate, and the dimensions of reagent chamber 3b are adjusted adequately. It is preferable to increase the number of rotations β to the number of rotations y and make the sample solution held in chamber 3b flow into chamber 5.

### A Fourth Example of the Sample Solution Analyzing Disk

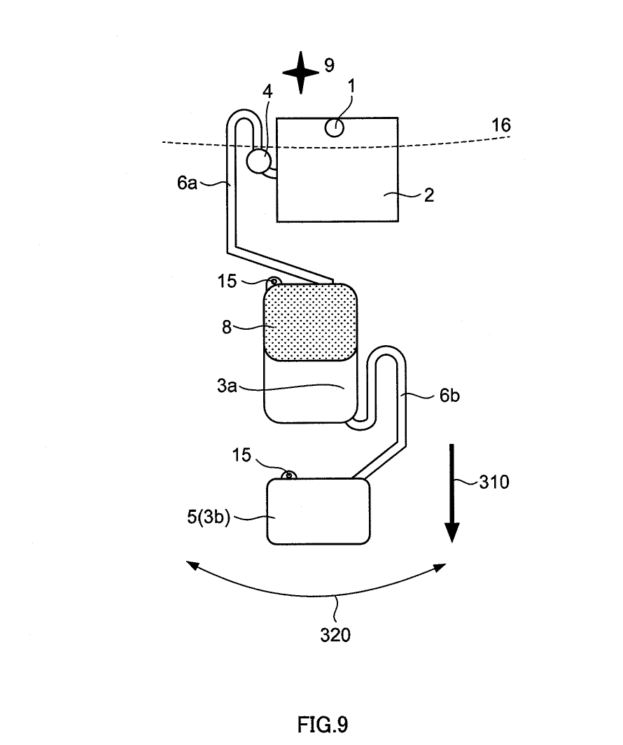

FIG. 9 is a plan view showing the configuration of a fourth example of the sample solution analyzing disk and shows part from rotation center 9 toward the radial direction. The sample solution analyzing disk shown in FIG. 9 is the same as the sample solution analyzing disk shown in FIG. 6 in that the sample solution analyzing disk has: sample solution storing chamber 2 which has sample solution supply port 1; flow path 6a which has flow path valve 4; and reagent chamber 3a where porous body 8 is placed. However, the sample solution analyzing disk shown in FIG. 9 is different from the sample solution analyzing disk shown in FIG. 6 in that reagent chamber 3b is also used as measuring chamber 5.

Compared to the sample solution analyzing disk shown in FIG. 6, the sample solution analyzing disk shown in FIG. 9 can reduce the steps for transferring the sample solution and reduce the members required to configure the flow paths and chambers. On the other hand, the time it requires to dissolve a reagent in the sample solution flowing into reagent chamber 3b uniformly and react the reagent with the sample solution, may become longer. Therefore, whether or not reagent chamber 3b and measuring chamber 5 are provided separately is preferably determined according to the properties of the reagent.

### A Fifth Example of the Sample Solution Analyzing Disk

The porous body placed in a chamber does not necessarily have to be confined in the chamber and may be exposed. FIG. 10 shows an example where the porous body placed in the chamber is exposed.

FIG. 10A is a cross-sectional plan view showing the configuration of the main part of the fifth example of the sample solution analyzing disk. On the other hand, FIG. 10B is a schematic view showing a longitudinal cross-section of the main part. FIG. 10 shows only the member matching reagent chamber 3a (reagent chamber in which the porous body is placed) shown in FIG. 6 and omits the other members.

Porous body 8 shown in FIG. 10 is not confined inside chamber 10, but is placed in an exposed manner. That is, porous body 8 is exposed on a substrate that configures the sample solution analyzing disk. Chamber 10 is provided so as to contact with porous body 8. Chamber 10 has a large opening part, and porous body 8 covers the opening part.

Further, porous body 8 is placed closer to rotation center 9 of the sample solution analyzing disk, than chamber 10. Therefore, the sample solution squeezed from porous body 8 by centrifugal force can be stored in the inner space of chamber 10.

Porous body 8 is preferably fixed by stopper 11 placed on the inner wall surface (for example, the lower substrate side of chamber 10) of chamber 10 and preferably not moved even if centrifugal force works by the rotation of the sample solution analyzing disk. To fix porous body 8 more reliably, a water-insoluble adhesive may be applied on the face that contacts with lower surface 14 of the porous body.

When the porous body placed in a chamber is exposed as in the sample solution analyzing disk shown in FIG. 10, drops of the sample solution can be dispensed directly when the disk is not rotating. Therefore, sample solution storing chamber 2 (see FIG. 6) with sample solution supply port 1 does not have to be provided. The dispensed sample solution is absorbed in the porous body and does not leak out.

The reagent in the porous body dissolves in the dispensed sample solution sufficiently, and, after the reaction proceeds, the sample solution analyzing disk is rotated centering around rotation center 9. The sample solution in the porous body is squeezed by centrifugal force caused by the rotation and flows into chamber 10.

The sample solution analyzing disk shown in FIG. 10 is suitable for use when the sample solution doesn't require pre-processing (for example, separation of blood cells in whole blood).

Although embodiments of the present invention have been described, conventional known methods and means can be used for matters which have not been particularly described in detail. Further, the design of the above embodiments can be modified variously within the scope of the present invention.

The sample solution analyzing disk of the present invention has a center of rotation. The disk can be fixed and rotated in a rotating apparatus with a fixing member having a shape that engages with a hole provided in the center of rotation of the disk. If the rotating apparatus has a measuring function, by measuring the properties of the sample solution flowing into the measuring chamber, the sample solution can be analyzed.

On the other hand, the rotating structure provided in the measuring device for measuring the properties of the sample solution may have a mechanism of holding the sample solution analyzing disk upon rotation. The rotating structure has an axis connected to the driving apparatus such as a motor, and a bearing structure, and holds the sample solution analyzing disk in the plane that is perpendicular to the rotation axis. In this case, the rotation axis does not have to be provided in the sample solution analyzing disk, and the projection shape may adopt various shapes other than a round shape. For example, as shown in FIG. 11, sample solution analyzing disk 101 can be fit in a groove in rotating structure 401 driven by driving apparatus 402 and rotated.

When the rotating structure holds the sample solution analyzing disk, preferably, attention is paid so as not to dislocate the center of rotation of the disk when the rotating structure provided in the measuring device rotates the sample solution analyzing disk. For example, weight distribution is optimized in advance or an adjusting mechanism is provided so that the gravity center of the rotating structure that rotates the disk comes on the rotation axis of the disk.

The present invention will be described further in detail using the following examples. These examples are not to be construed as limiting the scope of the present invention.

### EXAMPLES

### Example 1

The sample solution analyzing disk shown in FIG. 6 was prepared, and the concentration of HDL cholesterol (HDL-C) in plasma was measured. The sample solution analyzing disk was built using two plate materials of polycarbonate for an upper substrate and a lower substrate, and a spacer plate material of polyethylene terephthalate having a thickness of 100 μm, to which an adhesive was applied on both faces.

In one face of lower substrate 14, sample solution storing chamber 2, reagent chamber 3a, reagent chamber 3b and measuring chamber 5 were shaped.

The planar shape of reagent chamber 3a in lower substrate 14 was a rectangle 8 mm long and 5 mm wide when the direction centrifugal force worked by the rotation of the disk was the “longitudinal direction.” The depth of reagent chamber 3a was 0.2 mm in the part where the porous body was placed and 0.1 mm in the other parts. The planar shape of the part where the porous body was placed was a rectangle 3 mm long and 5 mm wide, and the porous body was placed in the part closer to rotation center 9.

The planar shape of sample solution storing chamber 2 in lower substrate 14 was 5 mm long, 5 mm wide and 0.3 mm deep, when the direction centrifugal force worked by the rotation of the disk is the “longitudinal direction.” The part connecting with flow path 6a through which reagent chamber 2 and reagent chamber 3a communicated, was provided in the outermost position of reagent storing chamber 2 when the disk rotated. A cylinder with a depth of 0.3 mm and a diameter of 1.0 mm, was provided in midstream of flow path 6a. The planar shape of reagent chamber 3b in lower substrate 14 was 3 mm long, 5 mm wide and 0.2 mm deep when the direction centrifugal force worked by the rotation of the disk was the “longitudinal direction.” The planer shape of measuring chamber 5 in lower substrate 14 was a round with a diameter of 2 mm and a depth of 0.3 mm.

Upper substrate 12 was pasted to the lower substrate where the chamber was shaped, by sandwiching a spacer plate material of 100 μm thickness between the lower substrate and upper substrate 12. Therefore, the distance from the bottom face to the ceiling of reagent chamber 3a (that is, the depth of reagent chamber 3a) was 0.3 mm or 0.2 mm. The flow paths through which the chambers communicated were formed with spacer members, and so the depth of the flow paths was 100 μm. Further, the width of all flow paths was 0.5 mm.

A non-woven glass fabric (by Whatman Plc., F147-11, approximately 300 μm thick) cut in 3 mm×5 mm, was placed in the part where the porous body was placed. The farther side of the non-woven glass fabric (the porous body) from rotation center 9, was placed in the position 36 mm from rotation center 9. 5 μl of a reagent solution (a mixed aqueous solution of sodium phosphotungstic acid of 6 mg/ml and hydrate of magnesium chloride 12 of 4 mg/ml) is dropped in the non-woven glass fabric and dried. The reagent may be dried on the non-woven glass fabric before the non-woven glass fabric is cut. In this case, the reagent solution of the volume matching the size of the non-woven glass fabric is dropped and dried.

Reagent chamber 3b was arranged so that “the closer side of reagent chamber 3b to rotation center 9,” was farther from rotation center 9 than “the farther side of reagent chamber 3a from rotation center 9.” Reagent chamber 3a and reagent chamber 3b communicated through flow path 6b. The depth of reagent chamber 3b after the upper surface was pasted, was 300 μm.

On the other hand, powder obtained by freeze-drying a mixed aqueous solution of the following components, was pressed and hardened to be made in the form of a sheet. Six of these sheets were laid on top of one another and placed in reagent chamber 3b.

Cholesterol dehydrogenase (Amano 5 by Amano Enzyme Inc.) 0.7 kunits/ml;
2.5 wt % sucrose solution 2 μl;
Cholesterol esterase (T-18 by Asahi Kasei Corp.) 0.5 kunits/ml;
Diaphorase (by Asahi Kasei Corp.) 630 units/ml; and
60 mM NAD (nicotin adenine dinucleotide) solution 2 μl;
WST-9 (soluble tetrazolium, by Dojindo Laboratories) 60 mM

To adjust pH of the sample solution upon reaction, a Tris buffer is preferably used as a component of the sheet placed in reagent chamber 3b. However, a Tris buffer is not suitable for freeze dry, and so a Tris buffer of 0.3 M (3 μl) was dropped on the bottom surface of reagent chamber 3b, dried in air and solidified.

Measuring chamber 5 was provided and communicated with reagent chamber 3b. The depth of measuring chamber 5 after pasting was 400 μm.

5 μl of the sample solution (plasma) was supplied from sample solution supply port 1 (see FIG. 6) of the built sample solution analyzing disk. The disk was rotated at 2000 rpm for 10 seconds, and there by the sample solution was made to intrude into flow path 6a and exceed flow path valve 4. When the rotation of the disk was stopped, the sample solution further flowed into flow path 6a and stayed still before reagent chamber 3a. When the disk was rotated at 1000 rpm for 5 seconds in this state, porous body 8 was soaked in the sample solution quickly. In this case, the sample solution did not leak out from the farther part of porous body 8 from rotation center 9.

Then, the rotation speed was increased to 6000 rpm, and thereby the sample solution was squeezed from porous body 8 to the empty space of reagent chamber 3a. Approximately half (2.5 to 3 μl) of the supplied sample solution (plasma) drained to the empty space in 30 seconds. The squeezed sample solution did not increase even if the period of rotation was extended. On the other hand, although the rate of collection was improved if the number of rotations was further increased, the number of rotations was made 6000 rpm taking into consideration the stability of the device.

To facilitate the aggregation of lipoproteins other than HDL in the empty space of reagent chamber 3a, the number of rotations was decreased to 1000 rpm to weaken the centrifugal force, and the disk continued to rotate for 1 minute. Then, the number of rotations was increased to 6000 rpm again, and the generated aggregate was removed by centrifugal force.

Further, the sample solution was moved in a manner similar to the mechanism for sample solution transfer of the conventional sample solution analyzing disk, the solid reagent dissolved and was reacted with the sample solution in reagent chamber 3b, and, further, the absorbance of the sample solution led to measuring chamber 5, at a wavelength of 650 nm, was measured.

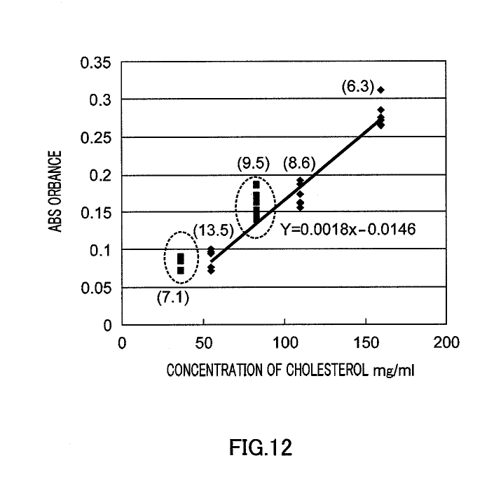

The measurement result is shown in FIG. 12 (with filled square). The vertical axis in the graph in FIG. 12 shows the measured absorbance, and the horizontal axis shows values obtained by measuring the concentration of HDL cholesterol in the same sample solution separately, using an analyzer (Hitachi 7020 by Hitachi, Ltd.). As shown in FIG. 12, the measured absorbance and the concentration of HDL cholesterol measured using the analyzer are proportional to each other. The numbers in parentheses in FIG. 12 are the CV values, that is, the coefficients of variation (%).

### Comparison Example 1

The measurement was performed in the same way as described above using the same sample solution analyzing disk except that a non-woven glass fabric (porous body) did not support the reagent (sodium phosphotungstic acid and magnesium chloride) for formation of aggregates. That is, the absorbance was measured using a system showing a change in the absorbance depending on the concentration of total cholesterol.

The measurement result is shown in the graph in FIG. 12 (with filled diamond). The vertical axis shows the measured absorbance, and the horizontal axis shows values obtained by measuring the concentration of HDL cholesterol in the same sample solution separately, using an analyzer.

As shown in FIG. 12, the correlation (filled square) between the value of the concentration of HDL cholesterol measured by the analyzer and the absorbance measured using the sample solution analyzing disk is in excellent agreement with the correlation (filled diamond) between the value of the concentration of total cholesterol measured by the analyzer and the absorbance measured using the sample solution analyzing disk.

By using the sample solution analyzing disk of the present invention other than the sample solution analyzing disk having the structure shown in FIG. 6, the same measurement result can be obtained.

By using a reaction system that can optically or electrically detect changes caused by chemical reactions on a desired component other than the concentration of HDL cholesterol in plasma, the component can be measured by the present invention.

### INDUSTRIAL APPLICABILITY

By using the sample solution analyzing disk of the present invention, a sample solution can be analyzed by detecting chemical reactions of a reagent reacting with the sample solution. The solid reagent can dissolve in the sample solution quickly and uniformly, so that it is possible to prevent uneven concentration of the dissolved reagent and secure accuracy of the detection. Therefore, the sample solution analyzing disk of the present invention is suitable for use as an apparatus of measuring blood components.

The disclosure of Japanese Patent Application No. 2006-072224, filed on Mar. 16, 2006, including the specification, drawings and abstract is incorporated herein by reference in its entirety.

1. A disk for analyzing a sample solution comprising:
one or more chambers with one or more opening parts which are provided in a disk member and which are formed with space;
a flow path which connects with the opening part;
a porous body which is placed in at least one of the chambers; and
a reagent which impregnates the porous body and which comprises a chemical substance that reacts with a specific component in the sample solution and that is soluble in the sample solution, wherein:
as a means for delivering the sample solution to the flow path and the chambers, a centrifugal force caused by rotation of the disk and a capillary force produced in the chambers and the flow path can be used;
the sample solution flows into the chamber in which the porous body is placed, through one of the opening parts by the centrifugal force caused by the rotation of the disk; and
the disk adopts a structure so that the centrifugal force can be set in a range such that the sample solution is stored in the porous body from making the porous body soak in the sample solution until dissolving of the chemical substance that impregnates the porous body in the sample solution, and the sample solution in which the porous body is soaked can be squeezed from the porous body when the centrifugal force is increased by an increase of the number of the rotations of the disk.

2. The disk according to claim 1, wherein the number of the chambers provided in the disk member is two or more, and the chambers communicate with each other through the flow path.

3. A disk for analyzing a sample solution comprising:
one or more chambers with one or more opening parts which are provided in a disk member and which are formed with space;
a flow path which connects with the opening part;
a porous body which is placed in at least one of the chambers; and
a reagent which impregnates the porous body and which comprises a chemical substance that reacts with a specific component in the sample solution and which is soluble in the sample solution, wherein:
as a means for delivering the sample solution to the flow path and the chambers, a centrifugal force caused by rotation of the disk and a capillary force produced in the chambers and the flow path can be used;
the porous body is placed so as to be exposed from the chamber, which is allowed to be impregnated with the sample solution from outside the disk member, and placed closer to a center of rotation of the disk member than the chamber; and
the disk adopts a structure so that the sample solution which impregnates the porous body can be stored in the porous body until a reagent supported in the porous body dissolves in the sample solution, and the sample solution in which the porous body is soaked can be squeezed from the porous body by the centrifugal force caused by the rotation of the disk.

4. The disk according to claim 3, wherein a number of the chambers provided in the disk member is two or more, and the chambers communicate with each other through the flow path.

5. The disk according to claim 1, wherein a size of inner space of the chamber where the porous body is placed is the same as the size of the porous body.

6. The disk according to claim 1, wherein inner space of the chamber where the porous body is placed has an empty space at the position farther from the center of rotation of the disk.

7. The disk according to claim 6, wherein an inner wall of the chamber where the porous body is placed has a step for fixing the porous body.

8. The disk according to claim 6, wherein the empty space has a greater volume than a volume of liquid squeezed from the porous body.

9. The disk according to claim 6, wherein a shape and size of a cross section of the inner space of the chamber where the porous body is placed, which cross section is orthogonal to a centrifugal direction of the rotation of the disk, are the same as a shape and size of a cross section of the porous body, which cross section is orthogonal to the centrifugal direction of the rotation of the disk.

10. The disk according to claim 2, comprising:
a first chamber where the porous body is placed;
a second chamber which has a greater volume than a volume of liquid squeezed from the porous body; and
a third chamber where a reagent used to analyze the sample solution is placed, wherein:
a size of the inner space of the first chamber where the porous body is placed is the same as a size of the porous body;
the first chamber is placed closer to a center of rotation of the disk than the second chamber; and
the second chamber is placed closer to the center of rotation of the disk than the third chamber.

11. The disk according to claim 2, comprising:
a first chamber where the porous body is placed; and
a third chamber where a reagent used to analyze the sample solution is placed, wherein:
inner space of the first chamber where the porous body is placed has an empty space at the position farther from the center of rotation of the disk, and the empty space has a greater volume than a volume of liquid squeezed from the porous body; and
the first chamber is placed closer to the center of rotation of the disk than the third chamber.

12. The disk according to claim 11, wherein:
the chambers connected in series by the flow path are placed so as to be farther from the center of rotation in the order of connections; and
the flow path connecting the chambers placed so as to be farther in the order of connections, has a pathway that moves away from the center of rotation without turning to the center of rotation, to connect from a chamber closer to the center of rotation to a neighboring chamber farther from the center of rotation.

13. The disk according to claim 12, wherein:
the sample solution can be moved from the chamber (chamber A) which is closer to the center of rotation, to the neighboring chamber (chamber B) which is farther from the center of rotation, by the rotation of the disk;
the porous body is placed in the chamber A, and the chamber A has the empty space at the position farther from the center of rotation;
the rotation provides the sample solution held in the porous body placed in the chamber A with greater centrifugal force than a capacity of the porous body for holding the sample solution; and
the rotation provides the sample solution in the empty space of the chamber A with smaller centrifugal force than a deterrent force against inflow of the sample solution to a flow path that leads to the chamber B.

14. The disk according to claim 1, wherein the reagent that impregnates the porous body comprises a polyanion compound or its salt, and a compound that generates a divalent positive ion in the sample solution.

15. The disk according to claim 14, wherein the polyanion compound is a heparin, and the divalent positive ion is a magnesium ion or a calcium ion.

16. The disk according to claim 14, wherein the polyanion compound is a dextran sulfate, a phosphotungstic acid, or their salt, and the divalent positive ion is a magnesium ion.

17. The disk according to claim 2, wherein inner space of the chamber where the porous body is placed has an empty space at the position farther from the center of rotation of the disk.

18. The disk according to claim 3, wherein inner space of the chamber where the porous body is placed has an empty space at the position farther from the center of rotation of the disk.

19. The disk according to claim 4, wherein inner space of the chamber where the porous body is placed has an empty space at the position farther from the center of rotation of the disk.

20. The disk according to claim 4, comprising:
a first chamber where the porous body is placed; and
a third chamber where a reagent used to analyze the sample solution is placed, wherein:
inner space of the first chamber where the porous body is placed has an empty space at the position farther from the center of rotation of the disk, and the empty space has a greater volume than a volume of liquid squeezed from the porous body; and
the first chamber is placed closer to the center of rotation of the disk than the third chamber.

21. The disk according to claim 3, wherein the reagent that impregnates the porous body comprises a polyanion compound or its salt, and a compound that generates a divalent positive ion in the sample solution.
